(19) United States
(12) Patent Application Publication
(10) Pub. No.: US 2026/0106703 A1
(43) Pub. Date: Apr. 16, 2026

(54) METHOD AND DEVICE FOR INDICATING UPLINK WAVEFORM, AND MEDIUM AND PRODUCT

(71) Applicant: Beijing Xiaomi Mobile Software Co., Ltd., Beijing (CN)

(72) Inventor: Xueyuan GAO, Beijing (CN)

(21) Appl. No.: 19/114,763

(22) PCT Filed: Sep. 26, 2022
(86) PCT No.: PCT/CN2022/121478

§ 371 Date: Mar. 24, 2025

(51) Int. Cl. H04L 5/00; H04L 27/26

(52) U.S. Cl. CPC H04L 5/0044; H04L 27/2636; H04L 27/2678

(57) ABSTRACT

A method for indicating an uplink waveform, including: a terminal receives downlink control information (DCI) carrying a first indication domain, where all or a portion of codepoints in the first indication field is configured to indicate an uplink waveform of the terminal using single-frequency network (SFN) transmission.

### CROSS-REFERENCE TO RELATED APPLICATIONS

The present application is a U.S. National Stage of International Application No. PCT/CN2022/121478, filed on Sep. 26, 2022, the contents of all of which are incorporated herein by reference in their entireties for all purposes.

### BACKGROUND OF THE INVENTION

Coordinated multi-point is still an important technical means in a new radio (NR) system. The coordinated multi-point may improve coverage at an edge of a cell and provide a more balanced quality of service in a service area.

### SUMMARY OF THE INVENTION

The present disclosure relates to the field of communications, and provides a method and device for indicating an uplink waveform, and a medium and a product.

According to an aspect of the embodiments of the present disclosure, a method for indicating an uplink waveform is provided, performed by a terminal, including:
receiving downlink control information (DCI) carrying a first indication field, where all or a portion of codepoints in the first indication field is configured to indicate an uplink waveform of the terminal using single-frequency network (SFN) transmission.

According to another aspect of the embodiments of the present disclosure, a method for indicating an uplink waveform is provided, performed by a network device, including:
transmitting DCI carrying a first indication field, where all or a portion of codepoints in the first indication field is configured to indicate an uplink waveform of a terminal using SFN transmission.

According to another aspect of the embodiments of the present disclosure, a terminal is provided, including:
one or more processors; and
a transceiver connected with the one or more processors;
where the one or more processors are collectively configured to load and execute executable instructions to:
receive downlink control information (DCI) carrying a first indication field, wherein all or a portion of codepoints in the first indication field is configured to indicate an uplink waveform of the terminal using single-frequency network (SFN) transmission.

According to another aspect of the embodiments of the present disclosure, a network device is provided, including:
one or more processors; and
a transceiver connected with the one or more processors;
where the one or more processors are collectively configured to load and execute executable instructions to implement the methods for indicating the uplink waveform according to the above aspects.

### BRIEF DESCRIPTION OF DRAWINGS

In order to explain technical solutions in embodiments of the present disclosure more clearly, accompanying drawings that need to be used in descriptions of the embodiments will be briefly introduced below. Apparently, the accompanying drawings in the following descriptions are merely some embodiments of the present disclosure, and for those of ordinary skill in the art, on the premise of no creative work, other accompanying drawings may further be obtained from these accompanying drawings.

FIG. 1 is a schematic diagram of a communication system provided according to an example.

FIG. 2 is a schematic diagram of a communication system provided according to an example.

FIG. 3 is a schematic diagram of an uplink transmission flow provided according to an example.

FIG. 4 is a schematic diagram of an uplink transmission flow provided according to an example.

FIG. 5 shows a schematic diagram of a transmission solution provided by an example of the present disclosure.

FIG. 6 shows a schematic diagram of a DCI information field provided by an example of the present disclosure.

FIG. 7 shows a flowchart of a method for indicating an uplink waveform provided by an example of the present disclosure.

FIG. 8 shows a flowchart of a method for indicating an uplink waveform provided by an example of the present disclosure.

FIG. 9 shows a flowchart of a method for indicating an uplink waveform provided by an example of the present disclosure.

FIG. 10 shows a flowchart of a method for indicating an uplink waveform provided by an example of the present disclosure.

FIG. 11 is a block diagram of a device for indicating an uplink waveform provided according to an example of the present disclosure.

FIG. 12 is a block diagram of a device for indicating an uplink waveform provided according to an example of the present disclosure.

FIG. 13 is a schematic structural diagram of a terminal provided according to an example.

FIG. 14 is a schematic structural diagram of a network device provided according to an example.

### DETAILED DESCRIPTION OF THE INVENTION

Examples will be illustrated in detail here, and their instances are shown in the accompanying drawings. When the following description refers to the accompanying drawings, unless otherwise indicated, the same numbers in different accompanying drawings indicate the same or similar elements. Implementations described in the following examples do not represent all implementations consistent with the present disclosure. Rather, they are merely instances of devices and methods consistent with some aspects of the present disclosure as detailed in the appended claims.

In the related art, transmission is performed in directions of transmission and reception points (TRPs) of a plurality of base stations through a physical uplink shared channel (PUSCH), coordinated transmission in a time division multiplexing (TDM) transmission mode is mainly standardized at R17, and repetitions of the same information on the PUSCH are transmitted to different TRPs of the base stations through different transmission occasions (TOs) of a time domain. However, a transmission delay of this method is larger.

Thus, the introduction of more transmission multiplexing modes is considered in R18. How to support dynamic switching of uplink waveforms in an SFN transmission mode is a problem that needs to be solved.

As for this, the present disclosure provides a method and device for indicating an uplink waveform, and a medium and a product. By enhancing the first indication field in the DCI, the uplink waveform may be indicated in a simultaneous transmission via multi-panel (STxMP) scenario, thus supporting performing uplink transmission using a plurality of uplink waveforms in the STxMP scenario, while further supporting performing dynamic switching between different uplink waveforms.

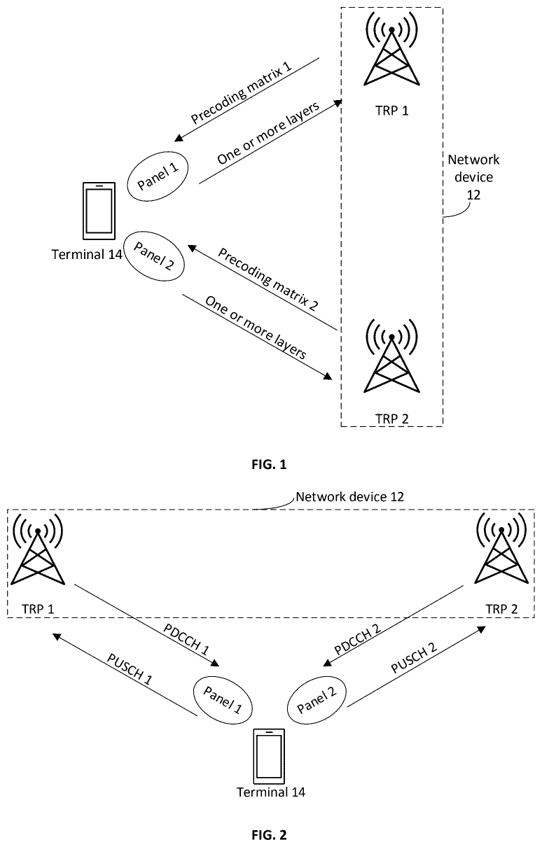

FIG. 1 shows a schematic diagram of a communication system provided by an example of the present disclosure. The communication system may include: a network device 12 and a terminal 14. The network device 12 includes a TRP1 and a TRP2.

The network device 12 may be a base station. The base station is a device that provides a wireless communication function for the terminal 14. The base station may include various forms of macro base stations, micro base stations, relay stations, access points, etc. In systems adopting different wireless access technologies, a name of a device with a base station function may vary, e.g., in a long term evolution (LTE) system, it is referred to as an eNodeB (CNB), and in a 5G NR system, it is referred to as a gNodeB (gNB). As a communication technology evolves, the description “base station” may change. For convenience of the description in the embodiment of the present disclosure, the above devices that provide the wireless communication function for the terminal 14 are collectively referred to as the network device 12.

The terminal 14 may include various handheld devices, in-vehicle devices, wearable devices, and computing devices with wireless communication functions or other processing devices connected to a wireless modem, as well as various forms of user equipment, mobile stations (MSs), terminal devices, etc. For convenience of description, the devices mentioned above are collectively referred to as the terminal.

For example, two communication scenarios exist between the network device 12 and the terminal 14: an uplink communication scenario and a downlink communication scenario. The uplink communication means that the terminal 14 transmits a signal to the network device 12. The downlink communication means that the network device 12 transmits a signal to the terminal 14.

Uplink PUSCH transmission is transmission in directions of TRPs of a plurality of base stations, coordinated transmission in a TDM transmission mode is mainly standardized at a version R17 of a third generation partnership project (3GPP), and repetitions of the same information on the PUSCH are transmitted to different TRPs of the base stations through different TOs of a time domain. This method has lower requirements for a terminal capability, does not demand a capability to support simultaneous transmission of beams, and has a larger transmission delay.

For uplink, in PUSCH channels oriented to different TRPs, spatial characteristics of the channels actually passed through may vary greatly, and thus spatial reception parameters of the PUSCH channels in different transmission directions are considered to be different.

In an enhancement goal of R18, it is mainly hoped to realize simultaneous coordinated transmission in the directions of the plurality of TRPs through a plurality of panels of the terminal to improve the reliability and throughput of transmission. At the same time, the transmission delay under the plurality of TRPs may be effectively reduced, but the terminal is demanded to have a capability to transmit a plurality of beams simultaneously. PUSCH transmission may be based on multi-panel TRP transmission scheduled by a single physical downlink control channel (PDCCH), i.e., single downlink control information (S-DCI), as shown in FIG. 1. PUSCH transmission may also be based on multi-panel TRP transmission scheduled by different PDCCHs, i.e., multi-downlink control information (M-DCI), as shown in FIG. 2.

As shown in FIG. 1, a precoding matrix 1 and a precoding matrix 2 are scheduled directly or indirectly by a piece of DCI to the terminal. The terminal 14 transmits one or more layers of uplink data to the TRP1 based on the precoding matrix 1 using a panel 1. The terminal 14 transmits one or more layers of uplink data to the TRP2 based on the precoding matrix 2 using a panel 2.

As shown in FIG. 2, the TRP 1 transmits a first piece of DCI to the terminal 14 through a PDCCH 1, and the terminal 14 is scheduled to transmit a PUSCH 1 to the TRP 1 using the panel 1. A TRP 2 transmits a second piece of DCI to the terminal 14 through a PDCCH 2, and the terminal 14 is scheduled to transmit a PUSCH 2 to the TRP 2 using the panel 2.

The above TRP1 and TRP2 are two TRPs in the same cell.

In the STxMP scenario, an uplink transmission flow includes: codebook-based uplink transmission and non-codebook-based uplink transmission.

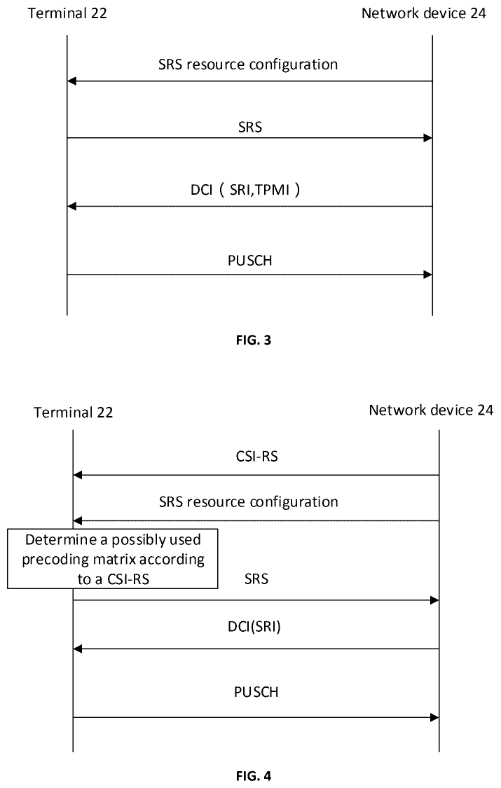

FIG. 3 shows a schematic diagram of a flow of codebook-based uplink transmission provided by an example of the present disclosure. The schematic diagram includes a terminal 22 and a network device 24.

In the flow of the codebook-based uplink transmission, the network device 24 first transmits a sounding reference signal (SRS) resource configuration to the terminal 22, and the SRS resource configuration includes at least one SRS resource and a time-frequency resource location for each SRS resource. Afterwards the terminal 22 transmits at least one SRS to the network device 24 based on the SRS resource configuration, the network device 24 obtains a channel condition of each uplink channel based on the received at least one SRS, and then provides DCI to the terminal 22, and the DCI at least includes an SRS resource indication (SRI) and a transmitted precoding matrix indicator (TPMI). Finally the terminal 22 transmits a PUSCH to the network device 24 based on the SRI and the TPMI.

FIG. 4 shows a schematic diagram of a flow of non-codebook-based uplink transmission provided by an example of the present disclosure. The schematic diagram includes a terminal 22 and a network device 24.

In the flow of the non-codebook-based uplink transmission, a precoding matrix is no longer limited to a fixed candidate set. The network device 24 first transmits a channel state information-reference symbol (CSI-RS) and SRS resource configuration information to the terminal 22, and an SRS resource configuration includes at least one SRS resource and a time-frequency resource location for each SRS resource. Afterwards the terminal 22 calculates and obtains on its own, based on a measurement result of the CSI-RS, by an algorithm such as singular value decomposition, at least one precoding matrix that may be used. Then the terminal 22 transmits at least one SRS to the network device 24 based on the SRS resource configuration, the network device 24 obtains a channel condition of each uplink channel based on the received at least one SRS, and then provides DCI to the terminal 22, and the DCI at least includes an SRI. Finally the terminal 22 determines a precoding matrix used this time from possibly used precoding matrices based on the SRI, and transmits a PUSCH to the network device 24 based on the SRI and the precoding matrix used this time.

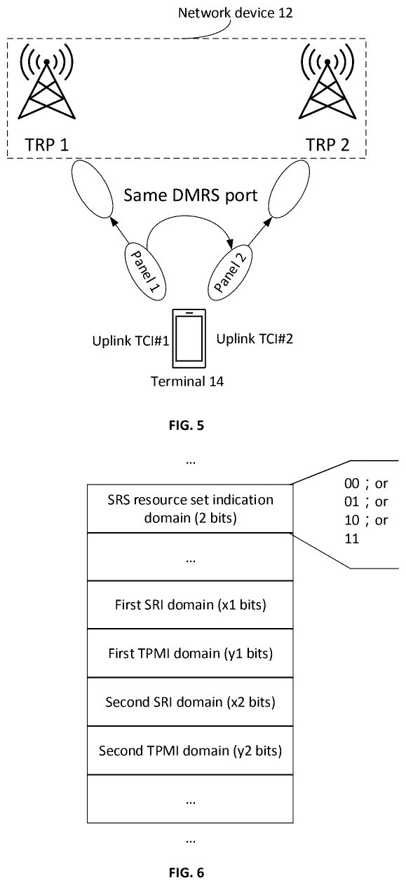

FIG. 5 shows a schematic diagram of an SFN transmission multiplexing mode provided by an example of the present disclosure. The schematic diagram includes a network device 12 and a terminal 14.

In the SFN transmission multiplexing mode, a transport block (TB) of the a PUSCH is transmitted to two different TRPs on the same time-frequency resource through the same DMRS port or port combination allocated on different panels respectively, and different panels/TRPs/TOs are associated with different transmission configuration indicator (TCI) states (i.e., beams) respectively.

The terminal 14 increases a probability that the network device 12 receives data through the SFN transmission mode, i.e., by transmitting the TB simultaneously to the plurality of TRPs of the network device 12, so as to realize a reliable uplink transmission.

For the SFN transmission mode, two uplink waveforms, cyclic prefix-orthogonal frequency division multiplexing (CP-OFDM) and discrete Fourier transform-spread-orthogonal frequency division multiplexing (DFT-S-OFDM) may be supported.

The CP-OFDM waveform is used for an uplink and downlink of a physical layer in an NR system, is applicable to a high throughput scenario, adopts a multiple input multiple output (MIMO) transmission mode, and provides high spectral packing efficiency in a resource block (RB), which may maximize the utilization of a network capacity in a dense city. The DFT-S-OFDM waveform is used for the uplink of the physical layer in the NR system, is applicable to a power constrained scenario, and adopts a transmission mode of single-layer transmission. Since a peak to average power ratio (PAPR) of the DFT-S-OFDM waveform is lower than that of the CP-OFDM, the DFT-S-OFDM waveform is more conducive to cell coverage and more suitable for transmission for a user at an edge of a cell.

According to above FIG. 3 and FIG. 4, the network device needs to transmit an SRS resource configuration to the terminal in advance. In the STxMP scenario, the following two configuration modes may exist.

The first possible SRS resource configuration mode: the network device configures the terminal with configurations of two SRS resource sets, where the two SRS resource sets include a first SRS resource set and a second SRS resource set, and the different SRS resource sets are associated with different panel information.

The second possible SRS resource configuration mode: the network device configures the terminal with a configuration of one SRS resource set, where the SRS resource set includes a first SRS resource subset and a second SRS resource subset, and different SRS resource subsets are associated with different panel information.

Optionally, the different panel information includes at least one of the following information:
different panels, a number of panels may be 2 or 4, and a default maximum in the embodiment of the present disclosure is 2;
different TRPs;
different TCI states; and
different TOs.

For the above two SRS resource configuration modes, an indication field of an SRS resource set in the DCI also needs to be redesigned, so that in the STxMP scenario, the network device can indicate to the terminal an SRS resource set that needs to be associated as well as an SRI/TPMI field in a single-TRP (s-TRP) or multi-TRP (m-TRP) scenario. FIG. 6 shows a schematic diagram of a DCI information field provided by an example of the present disclosure. In conjunction with reference to FIG. 6, a plurality of information fields are included in DCI, and a field of the plurality of information fields that is relevant to the present application include: an indication field of an SRS resource set (2 bits), a first SRI field (x1 bits), a second SRI field (x2 bits), a first TPMI field (y1 bits), and a second TPMI field (y2 bits). For a non-codebook case, the indication field of the SRS resource set SRS resource set and two SRI fields are used. For a codebook case, the indication field of the SRS resource set, two SRI fields, and two TPMI fields are used. x1, x2, y1, and y2 are variable values.

For coordinated transmission (non-simultaneous transmission) in the TDM transmission mode, a meaning of each codepoint in the indication field of the SRS resource set is designed as shown in Table 1 below:

TABLE 1

| | | SRI (for non-codebook and |
|---|---|---|
| | | codebook)/TPMI (merely |
| Codepoint | SRS resource set | codebook) field |
| 00 | s-TRP mode and | First SRI/TPMI field (second |
| | associated with a first | SRI/TPMI field not used) |
| | SRS resource set (TRP1) | |
| 01 | s-TRP mode and | First SRI/TPMI field (second |
| | associated with a second | SRI/TPMI field not used) |
| | SRS resource set (TRP2) | |
| 10 | m-TRP mode association | A first SRI/TPMI field and a |
| | (first SRS resource set, | second SRI/TPMI field are |
| | and second SRS resource | simultaneously used |
| | set) | |
| 11 | m-TRP mode association | A first SRI/TPMI field and a |
| | (second SRS resource set, | second SRI/TPMI field are |
| | and first SRS resource set) | simultaneously used |

The meaning of each codepoint in Table 1 is as follows.

When the codepoint of the indication field of the SRS resource set is 00, it is configured to indicate that the terminal transmits a PUSCH to the TRP1 using the s-TRP mode, associated with the first SRS resource set. In the codebook-based transmission mode, the SRI and TPMI used for this transmission are obtained using the first SRI/TPMI field in the DCI. In the non-codebook-based transmission mode, the SRI used for this transmission is obtained using the first SRI field in the DCI. At this time, the second SRI/TPMI field is not used.

When the codepoint of the indication field of the SRS resource set is 01, it is configured to indicate that the terminal transmits a PUSCH to the TRP2 using the s-TRP mode, associated with the second SRS resource set. In the codebook-based transmission mode, the SRI and TPMI used for this transmission are obtained using a first SRI/TPMI field in the DCI. In the non-codebook-based transmission mode, the SRI used for this transmission is obtained using the first SRI field in the DCI. At this time, the second SRI/TPMI field is not used.

When the codepoint of the indication field of the SRS resource set is 10, it is configured to indicate that the terminal first transmits the PUSCH to the TRP1 in a first TO using the m-TRP mode, associated with the first SRS resource set, and then transmits the PUSCH to the TRP2 in a second TO. In the codebook-based transmission mode, the SRI and TPMI used for transmission to the TRP1 are obtained using the first SRI/TPMI field in the DCI, and the SRI and TPMI used for transmission to the TRP2 are obtained using the second SRI/TPMI field in the DCI. In the non-codebook-based transmission mode, the SRI used for transmission to the TRP1 is obtained using the first SRI/TPMI field in the DCI, and the SRI used for transmission to the TRP2 is obtained using the second SRI/TPMI field in the DCI.

When the codepoint of the indication field of the SRS resource set is 11, it is configured to indicate that the terminal first transmits the PUSCH to the TRP2 in the first TO using the m-TRP mode, associated with the second SRS resource set, and then transmits the PUSCH to the TRP1 in the second TO. In the codebook-based transmission mode, the SRI and TPMI used for transmission to the TRP2 are obtained using the second SRI/TPMI field in the DCI, and the SRI and TPMI used for transmission to the TRP1 are obtained using the first SRI/TPMI field in the DCI. In the non-codebook-based transmission mode, the SRI used for transmission to the TRP2 is obtained using the second SRI/TPMI field in the DCI, and the SRI used for transmission to the TRP1 is obtained using the first SRI/TPMI field in the DCI.

By analyzing Table 1, the codepoint 10 is designed for a TDM coordination mode in which the PUSCH is transmitted first to the TRP1 and then to the TRP2, and the codepoint 11 is designed for a TDM coordination mode in which the PUSCH is transmitted first to the TRP2 and then to the TRP1. While in the STxMP scenario, the terminal needs to transmit the PUSCH to the TRP1 and the TRP2 simultaneously. At this time, the codepoint 10 and the codepoint 11 in Table 1 will lose the indication meaning and become redundant codepoints.

To this end, the present disclosure proposes different design ideas that utilize the above redundant codepoints to indicate, in whole or in part, the uplink waveform used in the STxMP scenario.

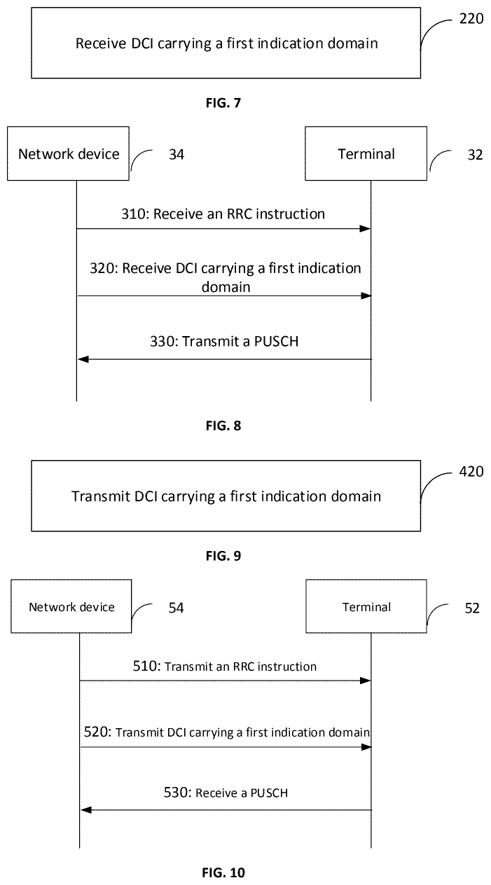

FIG. 7 shows a flowchart of a method for indicating an uplink waveform provided by an example of the present disclosure. This embodiment is explained by way of an example that the method is performed by a terminal. The method includes:

step 220: DCI carrying a first indication field is received.

The first indication field is an indication field in the DCI. For example, in some embodiments, the first indication field is an indication field of an SRS resource set in the DCI. In some embodiments, the first indication field is a newly added indication field in the DCI. In some embodiments, the first indication field is other indication fields in the DCI other than the indication field of the SRS resource set.

For example, all or a portion of codepoints in the first indication field is configured to indicate an uplink waveform of the terminal using SFN transmission. The uplink waveform includes at least one of: CP-OFDM or DFT-S-OFDM.

In some embodiments, all or a portion of the codepoints in the above-mentioned first indication field include a first codepoint and a second codepoint. The first codepoint is configured to indicate one of the two uplink waveforms above-mentioned, and the second codepoint is configured to indicate the other of the two uplink waveforms above-mentioned.

Three methods for indicating the uplink waveform are shown below by using three different indication fields in the DCI as the first indication field.

Method 1: the first indication field is the indication field of the SRS resource set.

As the previous description of Table 1, in the STxMP scenario, the codepoint 10 and codepoint 11 in Table 1 do not need to be used because the terminal needs to transmit the PUSCH to the TRP1 and the TRP2 simultaneously, so the redundant codepoint 10 and codepoint 11 may be configured to indicate the uplink waveform.

In some embodiments, the first codepoint is configured to indicate that the uplink waveform is the CP-OFDM in a case where a value of the first indication field is the first codepoint. The second codepoint is configured to indicate that the uplink waveform is the DFT-S-OFDM in a case where a value of the first indication field is the second codepoint.

For example, the first codepoint is 10, and the second codepoint is 11; or the first codepoint is 11, and the second codepoint is 10.

That is, in a possible case, in the case where the codepoint of the first indication field is 10, it indicates that the uplink waveform is CP-OFDM, and in the case where the codepoint of the first indication field is 11, it indicates that the uplink waveform is DFT-S-OFDM. In another possible case, in the case where the codepoint of the first indication field is 10, it indicates that the uplink waveform is DFT-S-OFDM, and in the case where the codepoint of the first indication field is 11, it indicates that the uplink waveform is CP-OFDM.

In a possible design, a possible design for a portion of the codepoints of the indication field of the SRS resource set in this embodiment is shown by way of an example that the first codepoint is 10 and the second codepoint is 11, as shown in Table 2:

TABLE 2

| | SRI field (codebook-based or non-codebook-based |
|---|---|
| Codepoint | transmission)/TPMI field (codebook-based transmission) |
| 10 | Indicating that an uplink waveform is CP-OFDM |
| 11 | Indicating that an uplink waveform is DFT-S-OFDM |

Method 2: the first indication field is the newly added indication field.

In some embodiments, the newly added indication field occupies 1 bit, i.e., 1 bit is newly added to the DCI to indicate the uplink waveform.

In some embodiments, a first value is configured to indicate that the uplink waveform is the CP-OFDM in a case where a value of the newly added indication field is the first value. A second value is configured to indicate that the uplink waveform is the DFT-S-OFDM in a case where a value of the newly added indication field is the second value.

For example, the first value is 0, and the second value is 1; or the first value is 1, and the second value is 0.

That is, in a possible implementation, in a case where a value of the first indication field is 0, it indicates that the uplink waveform is CP-OFDM, and in a case where the value of the first indication field is 1, it indicates that the uplink waveform is DFT-S-OFDM. In another possible implementation, in a case where the value of the first indication field is 1, it indicates that the uplink waveform is CP-OFDM, and in a case where the value of the first indication field is 0, it indicates that the uplink waveform is DFT-S-OFDM.

In a possible design, a possible design for the newly added indication field in this embodiment is shown by way of an example that the first value is 0 and the second value is 1, as shown in Table 3.

TABLE 3

| Value of a newly added | |
|---|---|
| indication field | Uplink waveform |
| 0 | CP-OFDM |
| 1 | DFT-S-OFDM |

Optionally, the uplink waveform is the CP-OFDM in a case where the newly added indication field is not configured. That is, if this newly added indication field is not configured, the uplink waveform is CP-OFDM by default.

Method 3: the first indication field is a target indication field in the DCI other than the indication field of the SRS resource set.

In addition to indicating the uplink waveform by the indication field of the SRS resource set and the newly added indication field, the uplink waveform may also be indicated by reserved codepoints in other existing indication fields in the DCI.

In some embodiments, the target indication field is an indication field in the DCI other than the indication field of the SRS resource set. The target indication field includes a reserved codepoint, and the reserved codepoint is configured to indicate the uplink waveform.

In some embodiments, the target indication field may be a frequency domain resource allocation indication field in the DCI, a time domain resource allocation indication field, an antenna port indication field, etc. The present application does not limit the selection of the target indication field in Method 3.

Taking an example that the target indication field is the time domain resource allocation (TDRA) indication field, a TDRA table corresponding to this TDRA indication field includes indication information configured to indicate the uplink waveform.

Optionally, for the above three methods for indicating the uplink waveform, an application principle enhancement is proposed: in a case where a rank is a third value, the first indication field is configured to indicate the uplink waveform of the terminal using the SFN transmission; or in a case where the rank is any value, the first indication field is invariably configured to indicate the uplink waveform of the terminal using the SFN transmission.

Optionally, the above third value is 1.

That is, in a case where the rank is equal to 1, the uplink waveform is indicated using the first indication field; or the first indication field may indicate the uplink waveform regardless of the value of the rank.

Optionally, the terminal first receives a radio resource control (RRC) instruction before receiving the DCI carrying the first indication field, and the RRC instruction is configured to indicate that simultaneous transmission via multi-panel (STxMP) is in an SFN transmission mode.

Optionally, the terminal transmits the PUSCH to the network device after receiving the DCI carrying the first indication field, and the PUSCH is transmitted applying the uplink waveform indicated by the first indication field.

It needs to be noted that the DCI carrying various indication fields mentioned in the present disclosure may refer to the same piece of DCI or to different pieces of DCI.

It needs to be noted that the methods mentioned in the present disclosure may all be implemented as a single embodiment or combined into an embodiment. For example, in some embodiments, the indication information for the uplink waveform is carried in the indication field of the SRS resource set; in some other embodiments, the indication information for the uplink waveform is carried in the newly added indication field; and in some other embodiments, the indication information for the uplink waveform is carried in the target indication field in the DCI other than the indication field of the SRS resource set. The present disclosure does not limit this.

In summary, the method provided by this embodiment, by enhancing the first indication field in the DCI, may realize the indication of the uplink waveform for transmitting the PUSCH in the STxMP scenario, thus supporting the use of the uplink waveforms of CP-OFDM and DFT-S-OFDM by the terminal in the STxMP scenario, as well as supporting dynamic switching between these two different uplink waveforms, which may further reduce the PAPR and improve a demodulation performance of the terminal and a system performance.

FIG. 8 shows a flowchart of a method for indicating an uplink waveform provided by an example of the present disclosure. This embodiment is explained by way of an example that the method is performed by a terminal 32. The method includes:

step 310: an RRC instruction is received.

For example, the terminal 32 receives the RRC instruction.

For example, the RRC instruction is configured to indicate that current STxMP transmission for an M-TRP uses an SFN transmission mode.

Step 320: DCI carrying a first indication field is received.

For example, the first indication field is an indication field in the DCI. For example, in some embodiments, the first indication field is an indication field of an SRS resource set in the DCI. In some embodiments, the first indication field is a newly added indication field in the DCI. In some embodiments, the first indication field is other indication fields in the DCI other than the indication field of the SRS resource set.

For example, all or a portion of codepoints in the first indication field is configured to indicate an uplink waveform of the terminal 32 using SFN transmission. The uplink waveform includes at least one of: CP-OFDM or DFT-S-OFDM.

For example, all or a portion of the codepoints in the above-mentioned first indication field include a first codepoint and a second codepoint. The first codepoint and the second codepoint are configured to indicate different uplink waveforms of the above-mentioned two uplink waveforms respectively.

The method for indicating the uplink waveform by the first indication field is seen in the embodiment shown in FIG. 7, which will not be repeated here.

Step 330: a PUSCH is transmitted.

For example, the terminal 32 transmits the PUSCH to the network device 34, and the PUSCH is transmitted applying the uplink waveform indicated by the first indication field. That is, the terminal 32 transmits the multi-panel PUSCH by applying the uplink waveform indicated by the first indication field in the DCI.

In summary, the method provided by this embodiment, by enhancing the first indication field in the DCI, may realize the indication of the uplink waveform for transmitting the PUSCH in the STxMP scenario, thus supporting the use of the uplink waveforms of CP-OFDM and DFT-S-OFDM by the terminal in the STxMP scenario, as well as supporting dynamic switching between these two different uplink waveforms, which may further reduce the PAPR and improve a demodulation performance of the terminal and a system performance.

FIG. 9 shows a flowchart of a method for indicating an uplink waveform provided by an example of the present disclosure. This embodiment is explained by way of an example that the method is performed by a network device. The method includes:

step 420: DCI carrying a first indication field is transmitted.

The first indication field is an indication field in the DCI. For example, in some embodiments, the first indication field is an indication field of an SRS resource set in the DCI. In some embodiments, the first indication field is a newly added indication field in the DCI. In some embodiments, the first indication field is other indication fields in the DCI other than the indication field of the SRS resource set.

For example, all or a portion of codepoints in the first indication field is configured to indicate an uplink waveform of the terminal using SFN transmission. The uplink waveform includes at least one of: CP-OFDM or DFT-S-OFDM.

In some embodiments, all or a portion of the codepoints in the above-mentioned first indication field include a first codepoint and a second codepoint. The first codepoint is configured to indicate one of the two uplink waveforms above-mentioned, and the second codepoint is configured to indicate the other of the two uplink waveforms above-mentioned.

Three methods for indicating the uplink waveform are shown below by using three different indication fields in the DCI as the first indication field.

Method 1: the first indication field is the indication field of the SRS resource set.

As the previous description of Table 1, in the STxMP scenario, the codepoint 10 and codepoint 11 in Table 1 do not need to be used because the terminal needs to transmit the PUSCH to the TRP1 and the TRP2 simultaneously, so the redundant codepoint 10 and codepoint 11 may be configured to indicate the uplink waveform.

In some embodiments, the first codepoint is configured to indicate that the uplink waveform is the CP-OFDM in a case where a value of the first indication field is the first codepoint. The second codepoint is configured to indicate that the uplink waveform is the DFT-S-OFDM in a case where a value of the first indication field is the second codepoint.

For example, the first codepoint is 10, and the second codepoint is 11; or the first codepoint is 11, and the second codepoint is 10.

That is, in a possible case, in the case where the codepoint of the first indication field is 10, it indicates that the uplink waveform is CP-OFDM, and in the case where the codepoint of the first indication field is 11, it indicates that the uplink waveform is DFT-S-OFDM. In another possible case, in the case where the codepoint of the first indication field is 10, it indicates that the uplink waveform is DFT-S-OFDM, and in the case where the codepoint of the first indication field is 11, it indicates that the uplink waveform is CP-OFDM.

In a possible design, a possible design for a portion of the codepoints of the indication field of the SRS resource set in this embodiment is shown by way of an example that the first codepoint is 10 and the second codepoint is 11, as shown in Table 4:

TABLE 4

| | SRI field (codebook-based or non-codebook-based |
|---|---|
| Codepoint | transmission)/TPMI field (codebook-based transmission) |
| 10 | m-TRP mode, indicating that an uplink waveform |
| | is CP-OFDM |
| 11 | m-TRP mode, indicating that an uplink waveform |
| | is DFT-S-OFDM |

Method 2: the first indication field is the newly added indication field.

In some embodiments, the newly added indication field occupies 1 bit, i.e., 1 bit is newly added to the DCI to indicate the uplink waveform.

In some embodiments, a first value is configured to indicate that the uplink waveform is the CP-OFDM in a case where a value of the newly added indication field is the first value. A second value is configured to indicate that the uplink waveform is the DFT-S-OFDM in a case where a value of the newly added indication field is the second value.

For example, the first value is 0, and the second value is 1; or the first value is 1, and the second value is 0.

That is, in a possible implementation, in a case where a value of the first indication field is 0, it indicates that the uplink waveform is CP-OFDM, and in a case where the value of the first indication field is 1, it indicates that the uplink waveform is DFT-S-OFDM. In another possible implementation, in a case where the value of the first indication field is 1, it indicates that the uplink waveform is CP-OFDM, and in a case where the value of the first indication field is 0, it indicates that the uplink waveform is DFT-S-OFDM.

In a possible design, a possible design for the newly added indication field in this embodiment is shown by way of an example that the first value is 0 and the second value is 1, as shown in Table 5:

TABLE 5

| Value of a newly added | |
|---|---|
| indication field | Uplink waveform |
| 0 | CP-OFDM |
| 1 | DFT-S-OFDM |

Optionally, the uplink waveform is the CP-OFDM in a case where the newly added indication field is not configured. That is, if this newly added indication field is not configured, the uplink waveform is CP-OFDM by default.

Method 3: the first indication field is a target indication field in the DCI other than the indication field of the SRS resource set.

In addition to indicating the uplink waveform by the indication field of the SRS resource set and the newly added indication field, the uplink waveform may also be indicated by reserved codepoints in other existing indication fields in the DCI.

In some embodiments, the target indication field is an indication field in the DCI other than the indication field of the SRS resource set. The target indication field includes a reserved codepoint, and the reserved codepoint is configured to indicate the uplink waveform.

In some embodiments, the target indication field may be a frequency domain resource allocation indication field in the DCI, a time domain resource allocation indication field, an antenna port indication field, etc. The present application does not limit the selection of the target indication field in Method 3.

Taking an example that the target indication field is the time domain resource allocation (TDRA) indication field, a TDRA table corresponding to this TDRA indication field includes indication information configured to indicate the uplink waveform.

Optionally, for the above three methods for indicating the uplink waveform, an application principle enhancement is proposed: in a case where a rank is a third value, the first indication field is configured to indicate the uplink waveform of the terminal using the SFN transmission; or in a case where the rank is any value, the first indication field is invariably configured to indicate the uplink waveform of the terminal using the SFN transmission.

Optionally, the above third value is 1.

That is, in a case where the rank is equal to 1, the uplink waveform is indicated using the first indication field; or the first indication field may indicate the uplink waveform regardless of the value of the rank.

Optionally, the network device first transmits a radio resource control (RRC) instruction before transmitting the DCI carrying the first indication field, and the RRC instruction is configured to indicate that simultaneous transmission via multi-panel (STxMP) is in an SFN transmission mode.

Optionally, the network device receives the PUSCH transmitted by the terminal after transmitting the DCI carrying the first indication field, and the PUSCH is transmitted applying the uplink waveform indicated by the first indication field.

It needs to be noted that the DCI carrying various indication fields mentioned in the present disclosure may refer to the same piece of DCI or to different pieces of DCI.

It needs to be noted that the methods mentioned in the present disclosure may all be implemented as a single embodiment or combined into an embodiment. For example, in some embodiments, the indication information for the uplink waveform is carried in the indication field of the SRS resource set; in some other embodiments, the indication information for the uplink waveform is carried in the newly added indication field; and in some other embodiments, the indication information for the uplink waveform is carried in the target indication field in the DCI other than the indication field of the SRS resource set. The present disclosure does not limit this.

In summary, according to the method provided by this embodiment, by enhancing the first indication field in the DCI, the network device may realize the indication of the uplink waveform for transmitting the PUSCH by the terminal in the STxMP scenario, thus supporting the use of the uplink waveforms of CP-OFDM and DFT-S-OFDM by the terminal in the STxMP scenario, as well as supporting dynamic switching between these two different uplink waveforms, which may further reduce a PAPR and improve a demodulation performance of the terminal and a system performance.

FIG. 10 shows a flowchart of a method for indicating an uplink waveform provided by an example of the present disclosure. This embodiment is explained by way of an example that the method is performed by a network device 54. The method includes:

step 510: an RRC instruction is transmitted.

For example, the network device 54 transmits the RRC instruction to the terminal 52.

For example, this RRC instruction is configured to indicate that current STxMP transmission for an M-TRP uses an SFN transmission mode.

Step 520: DCI carrying a first indication field is transmitted.

For example, the first indication field is an indication field in the DCI. For example, in some embodiments, the first indication field is an indication field of an SRS resource set in the DCI. In some embodiments, the first indication field is a newly added indication field in the DCI. In some embodiments, the first indication field is other indication fields in the DCI other than the indication field of the SRS resource set.

For example, all or a portion of codepoints in the first indication field is configured to indicate an uplink waveform of the terminal 52 using SFN transmission. The uplink waveform includes at least one of: CP-OFDM or DFT-S-OFDM.

For example, all or a portion of the codepoints in the above-mentioned first indication field include a first codepoint and a second codepoint. The first codepoint and the second codepoint are configured to indicate different uplink waveforms of the above-mentioned two uplink waveforms respectively.

The method for indicating the uplink waveform by the first indication field is seen in the embodiment shown in FIG. 9, which will not be repeated here.

Step 530: a PUSCH is received.

For example, the network device 54 receives the PUSCH transmitted by the terminal 52, and the PUSCH is transmitted applying the uplink waveform indicated by the first indication field. That is, the terminal 52 transmits the multi-panel PUSCH by applying the uplink waveform indicated by the first indication field in the DCI.

In summary, the method provided by this embodiment, by enhancing the first indication field in the DCI, may realize the indication of the uplink waveform for transmitting the PUSCH in the STxMP scenario, thus supporting the use of the uplink waveforms of CP-OFDM and DFT-S-OFDM by the terminal in the STxMP scenario, as well as supporting dynamic switching between these two different uplink waveforms, which may further reduce the PAPR and improve a demodulation performance of the terminal and a system performance.

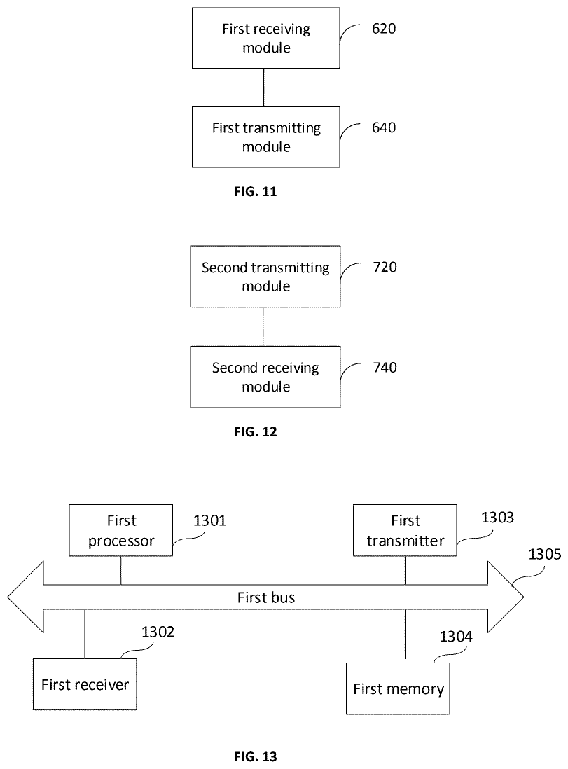

FIG. 11 shows a block diagram of a device for indicating an uplink waveform provided by an example of the present disclosure. The device includes:
a first receiving module 620, configured to receive downlink control information (DCI) carrying a first indication field, where all or a portion of codepoints in the first indication field is configured to indicate an uplink waveform of a terminal using single-frequency network (SFN) transmission.

In a possible design of this embodiment, the uplink waveform includes at least one of: cyclic prefix-orthogonal frequency division multiplexing (CP-OFDM), or discrete Fourier transform-spread-orthogonal frequency division multiplexing (DFT-S-OFDM).

In a possible design of this embodiment, the first indication field is an indication field of a sounding reference signal (SRS) resource set.

In a possible design of this embodiment, a first codepoint is configured to indicate that the uplink waveform is the CP-OFDM in a case where a value of the first indication field is the first codepoint; and a second codepoint is configured to indicate that the uplink waveform is the DFT-S-OFDM in a case where a value of the first indication field is the second codepoint.

In a possible design of this embodiment, the first codepoint is 10, and the second codepoint is 11; or the first codepoint is 11, and the second codepoint is 10.

In a possible design of this embodiment, the first indication field is a newly added indication field.

In a possible design of this embodiment, the newly added indication field occupies 1 bit.

In a possible design of this embodiment, a first value is configured to indicate that the uplink waveform is the CP-OFDM in a case where a value of the newly added indication field is the first value; and a second value is configured to indicate that the uplink waveform is the DFT-S-OFDM in a case where a value of the newly added indication field is the second value.

In a possible design of this embodiment, the first value is 0, and the second value is 1; or the first value is 1, and the second value is 0.

In a possible design of this embodiment, the uplink waveform is the CP-OFDM in a case where the newly added indication field is not configured.

In a possible design of this embodiment, the first indication field is a target indication field in the DCI other than an indication field of an SRS resource set.

In a possible design of this embodiment, the target indication field includes a reserved codepoint, and the reserved codepoint is configured to indicate the uplink waveform.

In a possible design of this embodiment, in a case where a rank is a third value, the first indication field is configured to indicate the uplink waveform of the terminal using the SFN transmission; or in a case where the rank is any value, the first indication field is invariably configured to indicate the uplink waveform of the terminal using the SFN transmission.

In a possible design of this embodiment, the third value is 1.

In a possible design of this embodiment, the first receiving module 620 is further configured to receive a radio resource control (RRC) instruction, where the RRC instruction configured to indicate that simultaneous transmission via multi-panel (STxMP) is in an SFN transmission mode.

In a possible design of this embodiment, the device further includes a first transmitting module 640. The first transmitting module 640 is configured to transmit a physical uplink shared channel (PUSCH), where the PUSCH is transmitted by applying the uplink waveform.

FIG. 12 shows a block diagram of a device for indicating an uplink waveform provided by an example of the present disclosure. The device includes:
a second transmitting module 720, configured to transmit downlink control information (DCI) carrying a first indication field, where all or a portion of codepoints in the first indication field is configured to indicate an uplink waveform of a terminal using single-frequency network (SFN) transmission.

In a possible design of this embodiment, the uplink waveform includes at least one of: cyclic prefix-orthogonal frequency division multiplexing (CP-OFDM), or discrete Fourier transform-spread-orthogonal frequency division multiplexing (DFT-S-OFDM).

In a possible design of this embodiment, the first indication field is an indication field of a sounding reference signal (SRS) resource set.

In a possible design of this embodiment, a first codepoint is configured to indicate that the uplink waveform is the CP-OFDM in a case where a value of the first indication field is the first codepoint; and a second codepoint is configured to indicate that the uplink waveform is the DFT-S-OFDM in a case where a value of the first indication field is the second codepoint.

In a possible design of this embodiment, the first codepoint is 10, and the second codepoint is 11; or the first codepoint is 11, and the second codepoint is 10.

In a possible design of this embodiment, the first indication field is a newly added indication field.

In a possible design of this embodiment, the newly added indication field occupies 1 bit.

In a possible design of this embodiment, a first value is configured to indicate that the uplink waveform is the CP-OFDM in a case where a value of the newly added indication field is the first value; and a second value is configured to indicate that the uplink waveform is the DFT-S-OFDM in a case where a value of the newly added indication field is the second value.

In a possible design of this embodiment, the first value is 0, and the second value is 1; or the first value is 1, and the second value is 0.

In a possible design of this embodiment, the uplink waveform is the CP-OFDM in a case where the newly added indication field is not configured.

In a possible design of this embodiment, the first indication field is a target indication field in the DCI other than an indication field of an SRS resource set.

In a possible design of this embodiment, the target indication field includes a reserved codepoint, and the reserved codepoint is configured to indicate the uplink waveform.

In a possible design of this embodiment, in a case where a rank is a third value, the first indication field is configured to indicate the uplink waveform of the terminal using the SFN transmission; or in a case where the rank is any value, the first indication field is invariably configured to indicate the uplink waveform of the terminal using the SFN transmission.

In a possible design of this embodiment, the third value is 1.

In a possible design of this embodiment, the second transmitting module 720 is further configured to transmit a radio resource control (RRC) instruction, where the RRC instruction configured to indicate that simultaneous transmission via multi-panel (STxMP) is in an SFN transmission mode.

In a possible design of this embodiment, the device further includes a second receiving module 740. The second receiving module 740 is configured to receive a physical uplink shared channel (PUSCH), where the PUSCH is transmitted by applying the uplink waveform.

FIG. 13 shows a schematic structural diagram of a terminal provided by an example of the present disclosure. The terminal includes: a first processor 1301, a first receiver 1302, a first transmitter 1303, a first memory 1304, and a first bus 1305.

The first processor 1301 includes one or more processing cores, and the first processor 1301 performs various functional applications as well as information processing by running software programs as well as modules.

The first receiver 1302 and the first transmitter 1303 may be implemented as a communication component, and the communication component may be a communication chip.

The first memory 1304 is connected with the first processor 1301 via the first bus 1305.

The first memory 1304 may be configured to store at least one instruction, and the first processor 1301 is configured to execute the at least one instruction to implement the various steps in the method embodiments above.

The first memory 1304 may be implemented by any type of volatile or nonvolatile storage device or their combination, and the volatile or nonvolatile storage device includes, but is not limited to: a magnetic disk or an optical disk, an electrically erasable programmable read only memory (EEPROM), an erasable programmable read only memory (EPROM), a static random-access memory (SRAM), a read only memory (ROM), a magnetic memory, a flash memory, and a programmable read only memory (PROM).

In an example, a non-temporary computer readable storage medium including instructions is further provided, such as a memory including instructions, and the above instructions may be executed by a processor of a terminal to complete the above method for indicating the uplink waveform. For example, the non-temporary computer readable storage medium may be a ROM, a random-access memory (RAM), a compact disc read only memory (CD-ROM), a magnetic tape, a floppy disk, an optical data storage device, etc.

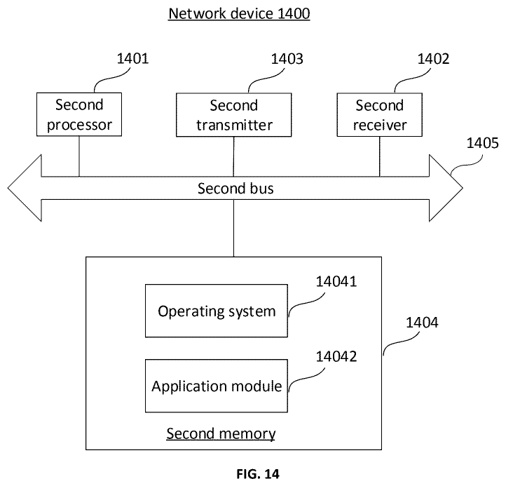

FIG. 14 is a block diagram of a network device 1400 illustrated according to an example. The network device 1400 may be a base station.

The network device 1400 may include: a second processor 1401, a second receiver 1402, a second transmitter 1403, and a second memory 1404. The second receiver 1402, the second transmitter 1403, and the second memory 1404 are each connected with the second processor 1401 via a second bus 1405.

The second processor 1401 includes one or more processing cores, and the second processor 1401 performs the method for indicating the uplink waveform provided by the embodiments of the present disclosure by running software programs as well as modules. The second memory 1404 may be configured to store software programs as well as modules. Specifically, the second memory 1404 may store an operating system 14041, and an application module 14042 needed for at least one function. The second receiver 1402 is configured to receive communication data transmitted by other devices, and the second transmitter 1403 is configured to transmit communication data to other devices.

An example of the present disclosure further provides a computer readable storage medium, storing at least one instruction, at least one segment of program, a code set, or an instruction set, and the at least one instruction, the at least one segment of program, the code set, or the instruction set being loaded and executed by a processor to implement the methods for indicating the uplink waveform according to the above method embodiments.

An example of the present disclosure further provides a computer program product, including computer instructions, the computer instructions are stored in a computer readable storage medium, a processor of a computer device reads the computer instructions from the computer readable storage medium, the processor executes the computer instructions, so that the computer device performs the methods for indicating the uplink waveform according to the above method embodiments.

As used herein, the term processor may refer to one processor that performs the defined functions or a plurality of processors that collectively perform defined functions, so that the execution of the individual defined functions may be divided amongst such processors.

It is to be understood that “a plurality of” referred to here refers to two or more. “And/or” describes the association relationship of associated objects, which means that there can be three kinds of relationships, for example, A and/or B can mean that there are three kinds of situations: A alone, A and B at the same time, and B alone. A character “/” universally indicates that front and back associated objects are in an “or” relationship.

Other implementation schemes of the present disclosure will be apparent to those skilled in the art from consideration of the specification and practice of the present disclosure here. The present disclosure is intended to cover any variations, uses, or adaptations of the present disclosure that follow the general principles of the present disclosure and include common knowledge or customary technical means in the art not disclosed in the present disclosure. The specification and embodiments are considered as examples merely, and the true scope and spirit of the present disclosure are indicated by the following claims.

It is to be understood that the present disclosure is not limited to the exact construction that has been described above and illustrated in the accompanying drawings, and that various modifications and changes may be made without departing from its scope. The scope of the present disclosure is merely limited by the appended claims.

1. A method for indicating an uplink waveform, performed by a terminal, the method comprising:
receiving downlink control information (DCI) carrying a first indication field, wherein all or a portion of codepoints in the first indication field is configured to indicate an uplink waveform of the terminal using single-frequency network (SFN) transmission.

2. The method according to claim 1, wherein the uplink waveform comprises at least one of the following:
cyclic prefix-orthogonal frequency division multiplexing (CP-OFDM); or
discrete Fourier transform-spread-orthogonal frequency division multiplexing (DFT-S-OFDM).

3. The method according to claim 2, wherein the first indication field is an indication field of a sounding reference signal (SRS) resource set.

4. The method according to claim 3, wherein
a first codepoint is configured to indicate that the uplink waveform is the CP-OFDM in a case where a value of the first indication field is the first codepoint; and
a second codepoint is configured to indicate that the uplink waveform is the DFT-S-OFDM in a case where a value of the first indication field is the second codepoint,
wherein the first codepoint is 10, and the second codepoint is 11; or the first codepoint is 11, and the second codepoint is 10.

5. (canceled)

6. The method according to claim 2, wherein the first indication field is a newly added indication field.

7. The method according to claim 6, wherein the method further comprises at least one of the following:
the newly added indication field occupies 1 bit; or
the uplink waveform is the CP-OFDM in a case where the newly added indication field is not configured.

8. The method according to claim 6, wherein
a first value is configured to indicate that the uplink waveform is the CP-OFDM in a case where a value of the newly added indication field is the first value; and
a second value is configured to indicate that the uplink waveform is the DFT-S-OFDM in a case where a value of the newly added indication field is the second value,
wherein the first value is 0, and the second value is 1; or the first value is 1, and the second value is 0.

9-10. (canceled)

11. The method according to claim 2, wherein the first indication field is a target indication field in the DCI other than an indication field of a sounding reference signal (SRS) resource set, and
wherein the target indication field comprises a reserved codepoint, wherein the reserved codepoint is configured to indicate the uplink waveform.

12. (canceled)

13. The method according to claim 1, wherein
the first indication field is configured to indicate the uplink waveform of the terminal using the SFN transmission in a case where a rank is a third value, or
the first indication field is invariably configured to indicate the uplink waveform of the terminal using the SFN transmission in a case where the rank is any value,
wherein the third value is 1.

14-16. (canceled)

17. A method for indicating an uplink waveform, performed by a network device, the method comprising:
transmitting downlink control information (DCI) carrying a first indication field, wherein all or a portion of codepoints in the first indication field is configured to indicate an uplink waveform of a terminal using single-frequency network (SFN) transmission.

18. The method according to claim 17, wherein the uplink waveform comprises at least one of the following:
cyclic prefix-orthogonal frequency division multiplexing (CP-OFDM); or
discrete Fourier transform-spread-orthogonal frequency division multiplexing (DFT-S-OFDM).

19. The method according to claim 18, wherein
the first indication field is an indication field of a sounding reference signal (SRS) resource set.

20. The method according to claim 19, wherein
a first codepoint is configured to indicate that the uplink waveform is the CP-OFDM in a case where a value of the first indication field is the first codepoint; and
a second codepoint is configured to indicate that the uplink waveform is the DFT-S-OFDM in a case where a value of the first indication field is the second codepoint,
wherein the first codepoint is 10, and the second codepoint is 11; or the first codepoint is 11, and the second codepoint is 10.

21. (canceled)

22. The method according to claim 18, wherein
the first indication field is a newly added indication field.

23. The method according to claim 22, wherein the method further comprises at least one of the following:
the newly added indication field occupies 1 bit; or
the uplink waveform is the CP-OFDM in a case where the newly added indication field is not configured.

24. The method according to claim 22, wherein
a first value is configured to indicate that the uplink waveform is the CP-OFDM in a case where a value of the newly added indication field is the first value; and
a second value is configured to indicate that the uplink waveform is the DFT-S-OFDM in a case where a value of the newly added indication field is the second value,
wherein the first value is 0, and the second value is 1; or the first value is 1, and the second value is 0.

25-26. (canceled)

27. The method according to claim 18, wherein
the first indication field is a target indication field in the DCI other than an indication field of a sounding reference signal (SRS) resource set, and
wherein the target indication field comprises a reserved codepoint, wherein the reserved codepoint is configured to indicate the uplink waveform.

28. (canceled)

29. The method according to claim 17, wherein
the first indication field is configured to indicate the uplink waveform of the terminal using the SFN transmission in a case where a rank is a third value;
or
the first indication field is invariably configured to indicate the uplink waveform of the terminal using the SFN transmission in a case where the rank is any value,
wherein the third value is 1.

30-34. (canceled)

35. A terminal, comprising:
one or more processors; and
a transceiver connected with the one or more processors;
wherein the one or more processors are collectively configured to lead and execute executable instructions to:
receive downlink control information (DCI) carrying a first indication field, wherein all or a portion of codepoints in the first indication field is configured to indicate an uplink waveform of the terminal using single-frequency network (SFN) transmission.

36. A network device, comprising:
one or more processors; and
a transceiver connected with the one or more processors;
wherein the one or more processors are collectively configured to execute executable instructions to implement the method for indicating the uplink waveform according to claim 17.

37-39. (canceled)
